(19) United States
(12) Patent Application Publication
(10) Pub. No.: US 2005/0264017 A1
(43) Pub. Date: Dec. 1, 2005

(54) Rotating ladle and rotating spatula

(76) Inventor: Thomas John Rauber, Dansville, NY (US)

Correspondence Address: THOMAS JOHN RAUBER, 6050 VISTA HILL, DANSVILLE, NY, 14437, US

(21) Appl. No.: 10/852,012

(22) Filed: May 25, 2004

(51) Int. Cl. A47J 43/28

(52) U.S. Cl. 294/8

(57) ABSTRACT

We have always had spatulas and ladles. They were simple in structure. My invention allows the user to handle the ladle and spatula with greater control, less effort and greater efficiency.

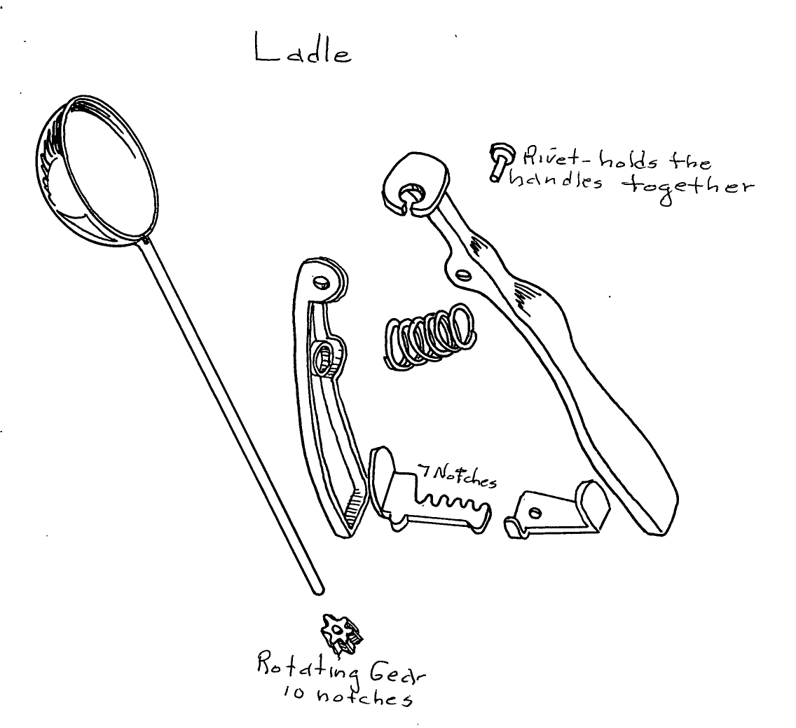

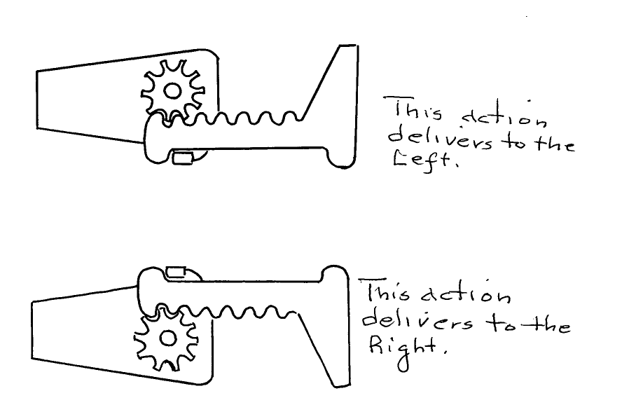

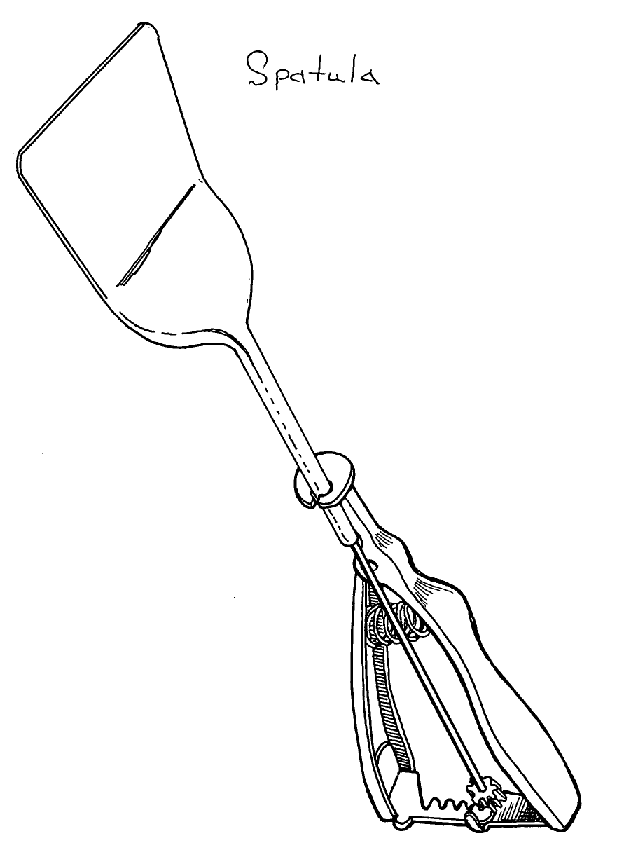

The invention will include 2 tools that use the same principle in their operation. No. 1 is a Ladle and No. 2 is a Spatula. The principle used in operating both 1 and 2 is that by holding the Ladle or Spatula in your hand and squeezing the two handles together the Ladle or Spatula will rotate to the left or the right. A coiled spring (shown in the drawings) between the handles allows the Ladle or Spatula to return to a normal position. By reversing the 7-notch straight gear from the right side to the left side, the round 10-notch gear will reverse the rotating action of the Ladle and Spatula from Left to Right. (Refer to Sheet 1 of 3)). Both the Ladle and Spatula will provide more efficiency in the preparation and serving of food. I have a working model of each. The drawings will give you a better understanding of their operation.

### EXPLANATION OF DRAWINGS

### Description of Parts

1. Spatula or Ladle on Shaft

2. End of Shaft Rotating Gear

3. Straight Gear

4. Stationary Handle

5. Moving Handle

6. Coil Spring

7. Angle Bracket holding Straight Gear

8. Rivet holding Handles Together

1. What I claim as my invention is that by squeezing the two handles of the Ladle or the Spatula allows the movement to the Left or to the Right depending on how the two gears are arranged. This turns the Spatula or Ladle over with greater ease just by squeezing the handle. They are to be used for greater ease, control and efficiency in the preparation and presentation of food. Referring to the drawing will be helpful.
